(19) United States
(12) Patent Application Publication
(10) Pub. No.: US 2019/0159629 A1
(43) Pub. Date: May 30, 2019

(54) BAKEWARE

(71) Applicant: Chih-Hao CHEN, Kaohsiung City (TW)

(72) Inventor: Chih-Hao CHEN, Kaohsiung City (TW)

(21) Appl. No.: 15/827,822

(22) Filed: Nov. 30, 2017

(51) Int. Cl. A47J 37/01; A21B 3/13

(52) U.S. Cl. CPC A47J 37/01; A23G 3/0252; A21B 3/13

(57) ABSTRACT

Bakeware has a body and a window. The body has a top surface, a bottom plate, a side wall, a chamber, a top opening, and a side opening. The side wall is formed around and protrudes out of the bottom plate. The chamber is formed in the body, is deposited above the bottom plate, and is enclosed by the side wall. The top opening is formed on the top surface of the body and is in communication with the chamber. The side opening is formed through the side wall and is in communication with the chamber. The window is transparent and is deposited on the side wall of the body for sealing the side opening of the body. The window of the bakeware is convenient to observe the baked degree of the food in the body.

### BACKGROUND OF THE INVENTION

### 1. Field of the Invention

The present invention relates to bakeware, and more particularly to bakeware that provides a window for observing the cooked situation of food in the bakeware.

### 2. Description of Related Art

With reference to FIG. 5, the conventional bakeware has a body 90, a chamber 91, and an opening 92. The body 90 is made of metal and is opaque. The chamber 91 is formed in the body 90. The opening 92 is formed on a top surface of the body 90 and communicates with the chamber 91.

Take cake baking for example. Users put dough and other ingredients into the chamber 91 of the conventional bakeware, and then put the conventional bakeware into an oven for baking the cake. The users may watch a top surface of the cake in the body 90 via the opening 92 of the conventional bakeware to judge the baked degree of the cake in the body 90.

However, the top surface of the cake in the body 90 directly contacts the heated air in the oven. A side surface of the cake in the body 90 directly contacts the body 90 of the conventional bakeware and indirectly contacts the heated air in the oven. The users can only directly watch the top surface of the cake in the body 90, but cannot watch the side surface of the cake in the body 90. The top surface of the cake is baked faster than the side surface of the cake. The users cannot accurately judge the baked degree of the cake by watching the top surface of the cake in the body 90 without watching the side surface of the cake in the body 90. Yet the conventional bakeware does not allow the users to watch the side surface of the cake in the body 90. The conventional bakeware is not convenient for users to observe and judge the baked degree of the cake during baking.

To overcome the shortcomings, the present invention provides bakeware to mitigate or obviate the aforementioned problems.

### SUMMARY OF THE INVENTION

The objective of the invention is to provide bakeware that allows users to watch the side surface of food in the bakeware during baking.

The bakeware has a body and a window. The body has a top surface, a bottom plate, a side wall, a chamber, a top opening, and a side opening. The side wall of the body is formed around and protrudes out of the bottom plate. The chamber is formed in the body, is deposited above the bottom plate, and is enclosed by the side wall. The top opening of the body is formed on the top surface of the body and is in communication with the chamber of the body. The side opening of the body is formed through the side wall and is in communication with the chamber of the body. The window is transparent and is deposited on the side wall of the body for sealing the side opening of the body.

For baking a cake, users put the dough and other ingredients into the chamber of the body of the bakeware, and then put the bakeware into an oven to bake the dough into the cake. During the baking process, users may directly watch a top surface of the cake via the top opening of the body, and may watch a side surface of the cake via the window. Therefore, users may accurately judge the baked degree of cake by watching both the top surface and the side surface of the cake. The window of the bakeware makes it convenient to observe the baked degree of the cake in the body.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of bakeware in accordance with the present invention;

FIG. 2 is a front side view of the bakeware in FIG. 1;

FIG. 3 is an enlarged cross sectional side view of the bakeware along line 3-3 in FIG. 2;

FIG. 4 is an operational front side view of the bakeware in FIG. 2, showing a cake is in the bakeware; and

FIG. 5 is a perspective view of the conventional bakeware in accordance with the prior art.

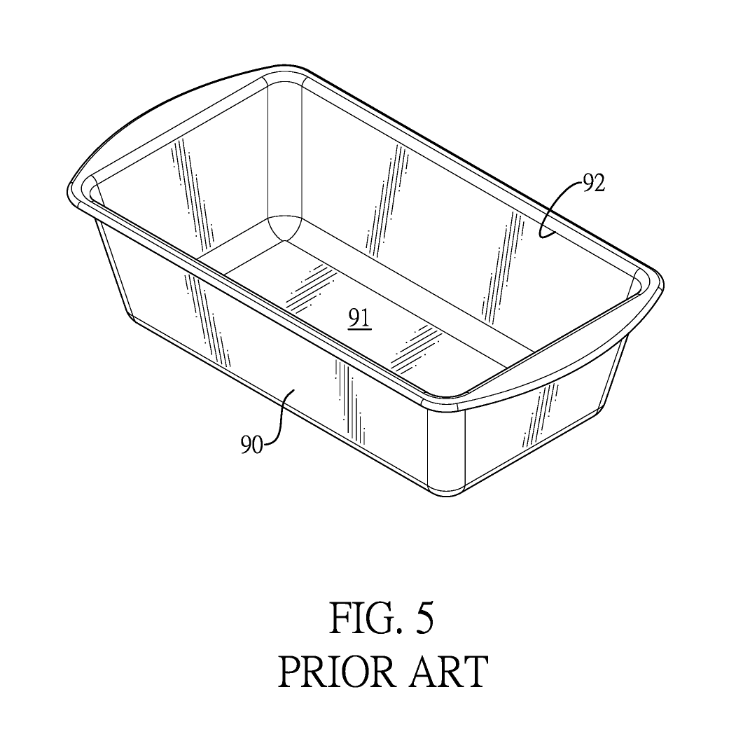

### DETAILED DESCRIPTION OF THE PREFERRED EMBODIMENT

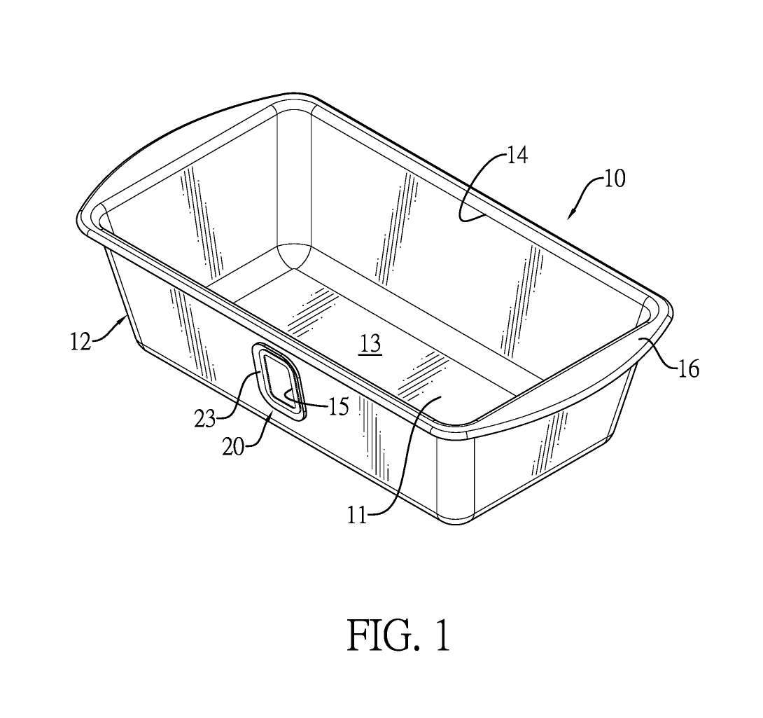

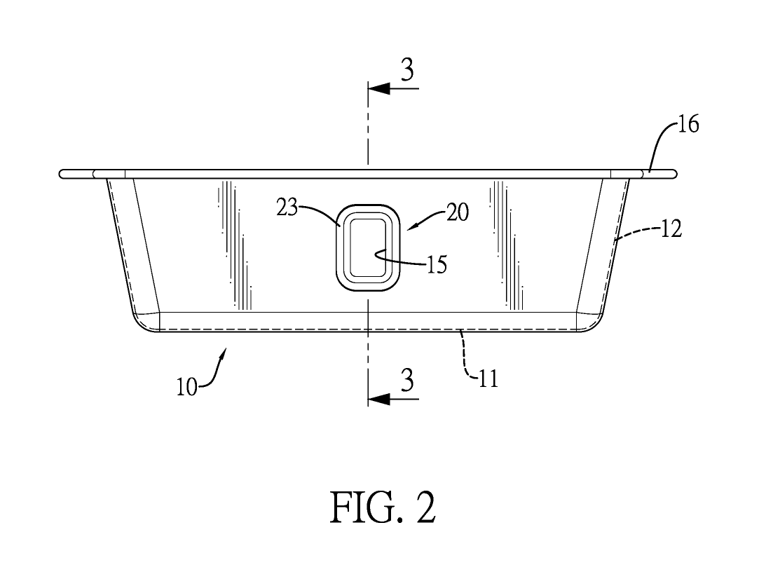

With reference to FIGS. 1 to 3, bakeware in accordance with the present invention comprises a body 10 and a window 20.

The body 10 has a top surface, a bottom plate 11, a side wall 12, a chamber 13, a top opening 14, and a side opening 15. The side wall 12 is formed around and protrudes out of a top surface of the bottom plate 11. The chamber 13 is formed in the body 10, is deposited above the bottom plate 11, and is enclosed by the side wall 12. The top opening 14 is formed on the top surface of the body 10 and communicates with the chamber 13 of the body 10. The side opening 15 is formed through the side wall 12 and communicates with the chamber 13 of the body 10. Furthermore, the body 10 has a wing 16. The wing 16 is annularly formed on and protrudes out of a top edge of the side wall 12. Furthermore, a shape of a top side view of the bottom plate 11 is not limited and may be a circle, an ellipse, or a rectangle. A shape of the side opening 15 is not limited and may be a circle, an ellipse, or a rectangle.

The window 20 is transparent and is deposited on the side wall 12 of the body 10 for sealing the side opening 15 of the body 10. Furthermore, the window 20 is made of a heat-resistant material and silicone.

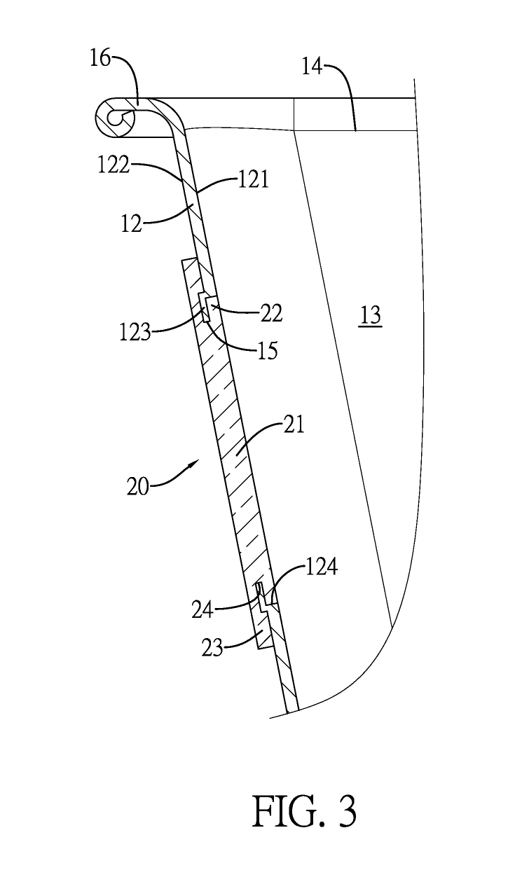

With reference to FIG. 3, the side wall 12 has an inner surface 121, an outer surface 122, a retaining portion 123, and a gap 124. The inner surface 121 is connected to the chamber 13 of the body 10. The outer surface 122 is opposite the inner surface 121 of the side wall 12. The retaining portion 123 is annularly formed on and protrudes out of the outer surface 122 of the side wall 12, and is deposited around the side opening 15 of the body 10. The gap 124 is formed on the inner surface 121 of the side wall 12 and is deposited around the side opening 15 of the body 10 adjacent to the retaining portion 123.

The window 20 has a base 21, an inner portion 22, an outer portion 23, and a retaining groove 24. The base 21 is deposited in the side opening 15 of the body 10 and is connected to the retaining portion 123. The inner portion 22 is formed around and protrudes out of the base 21. The inner portion 22 is inserted into the gap 124 of the side wall 12, is flush with the inner surface 121 of the side wall 12, and does not extend out of the inner surface 121 of the side wall 12. The outer portion 23 is formed around and protrudes out of the base 21, covers the retaining portion 123, and extends to the outer surface 122 of the side wall 12. The retaining groove 24 is formed between the inner portion 22 and the outer portion 23, and is deposited around the base 21.

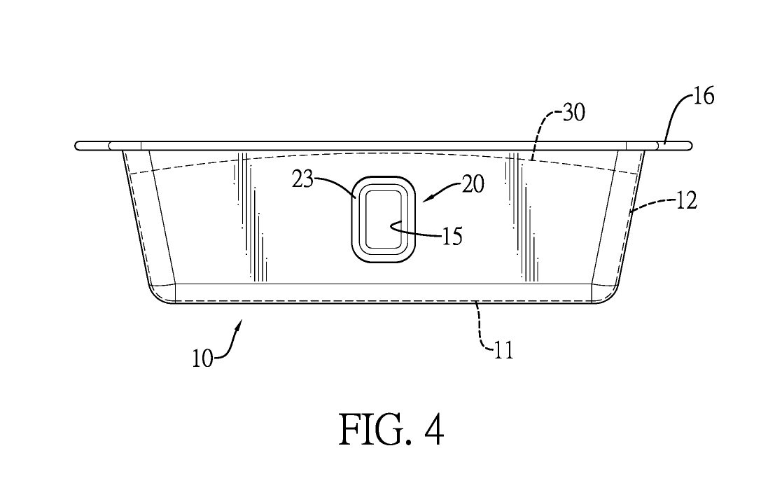

With reference to FIG. 4, the bakeware is used to contain the food for baking. For baking a cake 30, dough and other ingredients are put into the chamber 13 of the body 10 of the bakeware, and then the bakeware is put into an oven to bake the dough into the cake 30. Users may directly watch a top surface of the cake 30 in the bakeware via the top opening 14 of the body 10, and also may directly watch a side surface of the cake 30 in the bakeware via the window 20.

The inner portion 22 of the window 20 is inserted into the gap 124 of the side wall 12, and abuts against the retaining portion 123 of the side wall 12. The outer portion 23 of the window 20 covers the retaining portion 123 of the side wall 12. The window 20 can seal the side opening 15 of the body 10 and prevent the food in the bakeware from escaping via the side opening 15.

Accordingly, users may directly watch and observe the top surface and the side surface of food in the bakeware via the top opening 14 and the window 20. The window 20 of the bakeware is transparent, making it convenient to observe the baked degree of the side surface of food in the body 10. Thus, users may accurately judge whether the baking of food in the bakeware is finished or not by the baked degrees of the top surface and the side surface of the food.

In addition, the window 20 is detachably deposited on the side wall 12 of the body 10 for facilitating convenience of cleaning the bakeware. The window 20 is made of a heat-resistant material and silicone for improving food safety.

What is claimed is:

1. Bakeware comprising:
a body having
a top surface;
a bottom plate;
a side wall formed around and protruding out of the bottom plate;
a chamber formed in the body, deposited above the bottom plate, and enclosed by the side wall;
a top opening formed on the top surface of the body and communicating with the chamber of the body; and
a side opening formed through the side wall and communicating with the chamber of the body; and
a window being transparent and deposited on the side wall of the body for sealing the side opening of the body.

2. The bakeware as claimed in claim 1, wherein
the side wall has
an inner surface connected to the chamber of the body;
an outer surface being opposite the inner surface of the side wall;
a retaining portion annularly formed on and protruding out of the outer surface of the side wall and deposited around the side opening of the body; and
a gap formed on the inner surface of the side wall and deposited around the side opening of the body adjacent to the retaining portion; and
the window has
a base deposited in the side opening of the body and connected to the retaining portion;
an inner portion formed around and protruding out of the base and inserted into the gap of the side wall;
an outer portion formed around and protruding out of the base, covering the retaining portion, and extending to the outer surface of the side wall; and
a retaining groove formed between the inner portion and the outer portion and deposited around the base.

3. The bakeware as claimed in claim 1, wherein the window is made of a heat-resistant material.

4. The bakeware as claimed in claim 2, wherein the window is made of a heat-resistant material.

5. The bakeware as claimed in claim 1, wherein the window is made of silicone.

6. The bakeware as claimed in claim 2, wherein the window is made of silicone.

7. The bakeware as claimed in claim 3, wherein the window is made of silicone.

8. The bakeware as claimed in claim 4, wherein the window is made of silicone.

9. The bakeware as claimed in claim 1, wherein the body has a wing, and the wing is annularly formed on and protrudes out of the side wall.

10. The bakeware as claimed in claim 2, wherein the body has a wing, and the wing is annularly formed on and protrudes out of the side wall.

11. The bakeware as claimed in claim 3, wherein the body has a wing, and the wing is annularly formed on and protrudes out of the side wall.

12. The bakeware as claimed in claim 4, wherein the body has a wing, and the wing is annularly formed on and protrudes out of the side wall.

13. The bakeware as claimed in claim 5, wherein the body has a wing, and the wing is annularly formed on and protrudes out of the side wall.

14. The bakeware as claimed in claim 6, wherein the body has a wing, and the wing is annularly formed on and protrudes out of the side wall.

15. The bakeware as claimed in claim 7, wherein the body has a wing, and the wing is annularly formed on and protrudes out of the side wall.

16. The bakeware as claimed in claim 8, wherein the body has a wing, and the wing is annularly formed on and protrudes out of the side wall.
